(19) United States
(12) Patent Application Publication
(10) Pub. No.: US 2022/0374765 A1
(43) Pub. Date: Nov. 24, 2022

(54) FEATURE SELECTION BASED ON UNSUPERVISED LEARNING

(71) Applicant: BUSINESS OBJECTS SOFTWARE LTD., Dublin (IE)

(72) Inventors: Ying WU, Dublin (IE); Jiazheng LI, Dublin (IE); Paul O'HARA, Dublin (IE); Malte Christian KAUFMANN, Dublin (IE)

(21) Appl. No.: 17/328,427

(22) Filed: May 24, 2021

(51) Int. Cl. G06N 20/00; G06F 16/2457

(52) U.S. Cl. CPC G06N 20/00; G06F 16/24578

(57) ABSTRACT

Systems and methods include reception of a set of data, the set of data comprising a plurality of features, building, for each of a plurality of subsets of the plurality of features, a dimension reduction model based on the subset of features and associated values of the set of data, and, for each dimension reduction model, determination of a weight associated with each of subset of features based on the dimension model, identification of a predetermined number of features associated with the highest weights, and generation, for each dimension reduction model, of a data structure comprising the predetermined number of features and the weight associated with each of the predetermined number of features. A plurality of top features are determined based on the plurality of data structures, and a supervised learning model is trained based on the plurality of top features of the set of data.

### BACKGROUND

Today's organizations collect and store large volumes of data at an ever-increasing rate. Performing calculations upon or identifying patterns within this data can be time-consuming or even infeasible. Modern data analytics systems attempt to assist humans in efficiently understanding this data. Such systems may utilize purpose-designed mathematical functions, data mining and/or machine learning.

Supervised learning is a branch of machine learning in which a model is trained based on sets of training data, each of which is associated with a target output. More specifically, supervised learning algorithms iteratively train a model to map each set of training data input variables to an associated target output within a suitable margin of error. The trained model can then be used to predict an output based on a set of input data.

Each set of training data (e.g., a database row) includes values of many features (e.g., database columns). The trained model therefore takes each feature into account, to varying degrees which are learned during the training. Training data which includes a large number of features may result in a large trained model. A large trained model may be overfit to the training data, sensitive to noise and spurious relationships between the features and the output, slow to load and apply, slow to train, and difficult to interpret. Moreover, the predictive performance of a large trained model might not be appreciably better than that of a different model trained on fewer features of the training set.

Existing techniques attempt to reduce the number of features of a training set which are used to train a model, in the interest of generating a smaller trained model with suitable predictive performance. However, the processing requirements of such techniques can outweigh the resource savings of the resulting trained model. Systems are desired to efficiently identify desired training set features and generate a smaller, accurate, and interpretable model based thereon.

### BRIEF DESCRIPTION OF THE DRAWINGS

FIG. 1 is a block diagram of an architecture to determine features for model training according to some embodiments.

FIG. 2 comprises a flow diagram of a process to pre-process data according to some embodiments.

FIG. 3 is a tabular representation of a set of data according to some embodiments.

FIG. 4 is a tabular representation of a set of data as modified during pre-processing according to some embodiments.

FIG. 5 is a tabular representation of a set of data as modified during pre-processing according to some embodiments.

FIG. 6 is a tabular representation of a set of data as modified during pre-processing according to some embodiments.

FIG. 7 comprises a flow diagram of a process to generate multiple rankings of features according to some embodiments.

FIG. 8 is a tabular representation of multiple rankings of features according to some embodiments.

FIG. 9 comprises a flow diagram of a process to select features for model training based on multiple rankings of features according to some embodiments.

FIG. 10 is a tabular representation of selected features according to some embodiments.

FIG. 11 is a tabular representation of selected features according to some embodiments.

FIG. 12 illustrates a system to provide model training to applications according to some embodiments.

FIG. 13 is a block diagram of a hardware system for providing model training according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

As used herein, a feature refers to an attribute of a set of data. In the case of tabular data, each column may be considered as representing a respective feature, while each row is a single instance of values for each feature. A continuous feature is represented using numeric data having an infinite number of possible values within a selected range, and a discrete feature is represented by data having a discrete number of possible values, or discrete values. Temperature is an example of a continuous feature, while days of the week and gender are examples of a discrete feature.

According to some embodiments, a set of data undergoes pre-processing to remove undesirable features and to convert discrete features to continuous features. Multiple sets of candidate features are determined from the remaining features using a dimension reduction method. The sets of candidate features are then processed to select a final set of features for use in training a predictive model.

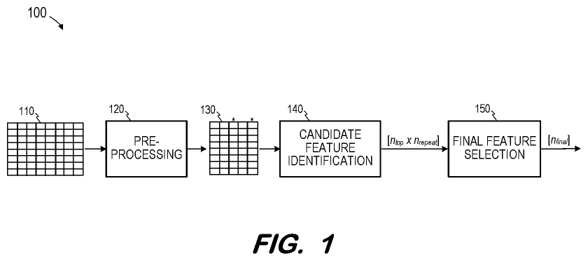

FIG. 1 is a block diagram of architecture 100 to determine features for model training according to some embodiments. The illustrated components may be implemented using any suitable combination of computing hardware and/or software that is or becomes known. In some embodiments, two or more components are implemented by a single computing device. Two or more components of FIG. 1 may be co-located. One or more components may be implemented as a cloud service (e.g., Software-as-a-Service, Platform-as-a-Service). A cloud-based implementation of any components of FIG. 1 may apportion computing resources elastically according to demand, need, price, and/or any other metric.

Data 110 may comprise database table values. More specifically, data 110 may comprise rows of a database table, with each row including a value of a corresponding database column, or feature. Data 110 consists of at least one discrete feature and at least one continuous feature which includes a target continuous feature. For example, data 110 may comprise a Sales table including the target continuous feature Margin.

Pre-processing component 120 processes the data 110 by initially identifying the target feature. Any feature which is associated with the same values as the target feature is removed from data 110. Features which are associated with the same values of other features are also removed from data 110. Lastly, the values of any discrete features are converted to continuous values based on the values of the target feature. As shown in the FIG. 1 example, data 130 output by pre-processing component 120 includes fewer features than input data 110. The asterisks associated with data 130 represent discrete features which have been converted to continuous values as mentioned above.

Candidate feature identification component 140 selects a random subset of non-target features of data 130, builds a dimension reduction model based thereon, and determines the most important (i.e., nₜₒₚ) features of the model. This process is repeated (i.e., nᵣₑₚₑₐₜ times), each time with a new random subset of non-target features, until several sets of most-important non-target features have been determined. These sets (i.e., [nₜₒₚ×nᵣₑₚₑₐₜ]) are then output to final feature selection component 150. Since the repetitions performed by component 140 are independent of one another, the repetitions are amenable to concurrent parallel execution, for example using a cloud implementation architecture.

Final feature selection component 150 determines a set of features (i.e., n_{final}, of data 110 to be used in training a predictive model to output a value of the target feature. The set of features is determined based on the sets of most-important features received from candidate feature identification component 140. The determination of the set of features may be based on weights associated with each feature appearing in the sets of most-important features and/or on a number of occurrences of each feature in the sets of most-important features.

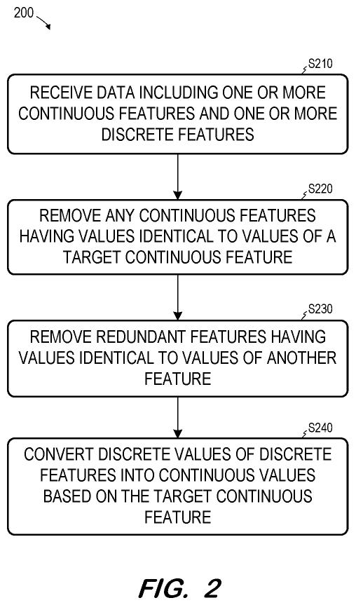

FIG. 2 is a flow diagram of process 200 to pre-process a set of input data according to some embodiments. Accordingly, process 200 may be implemented by pre-processing component 120, but embodiments are not limited thereto.

Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any one or more processing units, including but not limited to a processor, a processor core, and a processor thread. Embodiments are not limited to the examples described below.

Process 200 may be initiated by any request which may require selection of a subset of features of a set of data to be used for training a model. Such a request may comprise a request to generate a model to predict a value of a continuous feature of a data table based on other features of the data table. In one non-exhaustive example, an order fulfillment application may request generation of a model to predict product delivery times, where the model is to be trained based on actual product delivery times (i.e., ground truth data) contained in a database table which stores data associated with historical product orders.

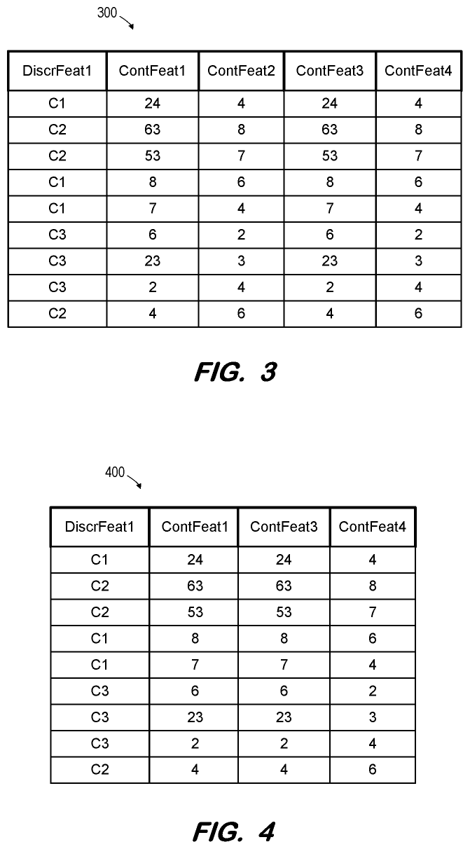

Initially, data including one or more continuous features and one or more discrete features is received at S210. The data includes values respectively associated with each of the features. Using the above example, the data may include rows representing product orders and each row may include values for the features OrderDate, StorageLocation, Delivery Address, Weight, etc. FIG. 3 is a tabular representation of rows of received data 300 according to some embodiments. Data 300 includes one discrete feature and four continuous features.

The received data also includes a specified target continuous feature. The target continuous feature represents the output of a model which is predicted based on a subset of the other features of the data. Using the above example, the target continuous feature is product delivery time. It will be assumed that continuous feature ConFeat4 is the target continuous feature of data 300.

At S220, any continuous features which are associated with values that are identical to (and in the same order as) the values associated with the target continuous feature are removed. With respect to a tabular example, columns which are identical to the column of the target continuous feature are removed at S220. The column of data 300 labeled ContFeat2 is identical to the column of continuous feature ConFeat4, and therefore this column is removed at S220, resulting in data 400 of FIG. 4.

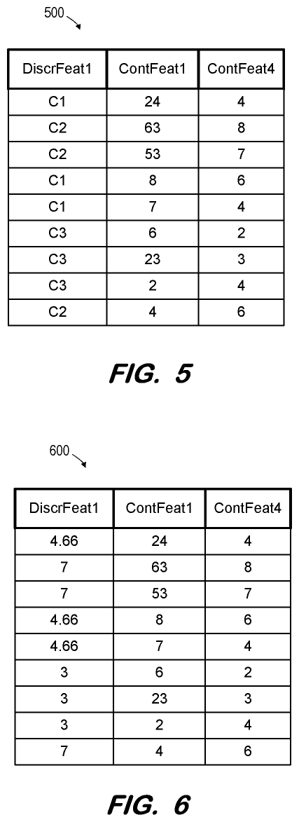

Next, at S230, any features which are redundant due to having values identical to another feature are removed. S230 is therefore similar to S220, but performed with respect to all features. For example, it is noted that features ContFeat1 and ContFeat3 of data 400 include identical values in an identical order. Accordingly, one of features ContFeat1 and ContFeat3 are removed at S230. FIG. 5 illustrates data 500 after removal of feature ContFeat3 at S230 according to some embodiments.

Removal of features at S220 and S230 is intended to reduce influence of too-highly-correlated features within the following processing. Moreover, since the following processing requires numerical values for each feature under consideration, the discrete values of all discrete features are converted to continuous values at S240. The conversion is based on the values of the target continuous feature as will be described below. Generally, each discrete value is replaced by the average of the target continuous feature values associated with the same discrete value. Mathematically:

$$New Discrete Value = \frac{{\sum }_{i = 0}^{\# rows having current discrete value} Target Value}{\#rows having current discrete value}$$

With reference to FIG. 5, each row associated with discrete value C1 is identified. The values of target feature ContFeat4 in each of the identified rows (i.e., 4, 6, 4) are averaged, and the average value (i.e., 4.66) is substituted for each appearance of C1 in column DiscrFeat1. The process repeats for each other discrete value of column DiscrFeat1, as shown in output data 600 of FIG. 6.

According to some embodiments, all non-target continuous features are subjected to similar discretization at S240. To transform a continuous feature, all its values are split into n_{bins} bins having equal intervals. Each bin is then treated as a single discrete value as above. Specifically, all continuous values associated with a same bin are replaced by the average of their corresponding target feature values. Again mathematically:

$$New Continuous Value = \frac{{\sum }_{i = 0}^{\# rows of current bin} Target Value}{\#rows of current bin}$$

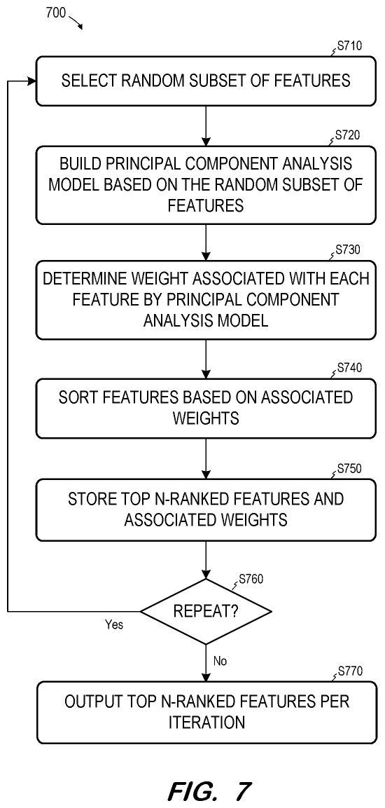

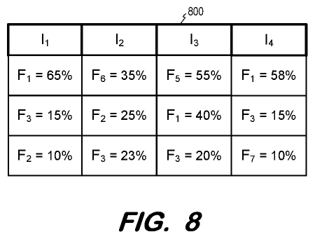

FIG. 7 is a flow diagram of process 700 to generate rankings of features according to some embodiments. Initially, at S710, a subset of n_{random} non-target features and their corresponding values is randomly-selected from the output of S240.

Next, at S720, a dimension reduction model is built based on the n_{random} features and their corresponding values. According to some embodiments, the dimension reduction model is a Principal Component Analysis (PCA) model. The PCA model is built by applying a known PCA algorithm to the data consisting of n_{random} features and their corresponding values.

PCA may be considered an orthogonal linear transformation that transforms the data to a new coordinate system such that the greatest variance by some scalar projection of the data is associated with the first coordinate (i.e., the first principal component), the second greatest variance is associated with the second coordinate, etc. PCA can be conceptualized as fitting a p-dimensional ellipsoid to the data, where each axis of the ellipsoid represents a principal component. If some axis of the ellipsoid is small, then the variance along that axis is also small.

The output of the PCA therefore includes importances associated with each non-feature of the current subset. The weight associated with each feature is determined from the importances at S730. In one example, a weight of a feature is a normalized importance of the feature, determined as a percentage of the importance with respect to the sum of all importances of all features.

The features are sorted based on the determined weights at S740, with those features associated with higher percentages being listed higher than features associated with lesser percentages. A predetermined number (i.e., nₜₒₚ) of most-important (i.e., highest-weighted) features are selected and stored at S750 along with their associated weights.

At S760 it is determined whether a desired number (e.g., nᵣₑₚₑₐₜ) of iterations of S710 through S750 have been performed. If not, flow returns to S710 and continues as described above. The iterations need not be successive and may be performed in parallel, for example using a cloud implementation architecture. Once nᵣₑₚₑₐₜ iterations have been performed, flow proceeds to S770 to output the nₜₒₚ features from each iteration.

FIG. 8 is a tabular example of [nₜₒₚ×nᵣₑₚₑₐₜ] data structure 800 output at S770 according to some embodiments. According to data structure 800, nₜₒₚ=3 and nᵣₑₚₑₐₜ=4. Each column of data structure 800 corresponds to the nₜₒₚ most-important features determined for iteration I and each row n represents the n-th most-important feature of each iteration I.

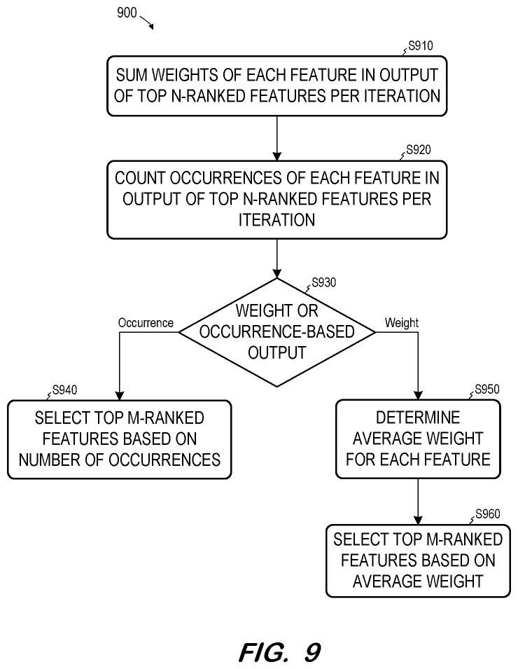

FIG. 9 comprises a flow diagram of process 900 to select features for model training based on the multiple rankings output by process 700 according to some embodiments.

At S910, for every feature which appears in data structure 800, all weights attributed to that feature are summed. For example, data structure 800 associates feature F₁ with weights 65%, 40% and 58%. Accordingly, a total weight of 163% is determined at S910 for feature F₁.

S920 includes determination of the number of occurrences of each feature in the output of process 700. Again with respect to data structure 800, S920 may include determination of three occurrences of feature F₁, two occurrences of feature F₂, four occurrences of feature F₄, etc.

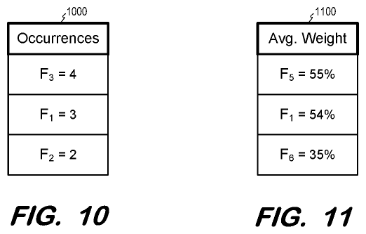

Next, at S930, it is determined whether the features are to be ultimately selected based on average weights or number of occurrences. If the latter, flow proceeds to S940 to select the top M-ranked features based on the number of occurrences determined for each feature at S920. FIG. 10 shows selected features 1000 determined at S930 based on data structure 800, and for which M=3.

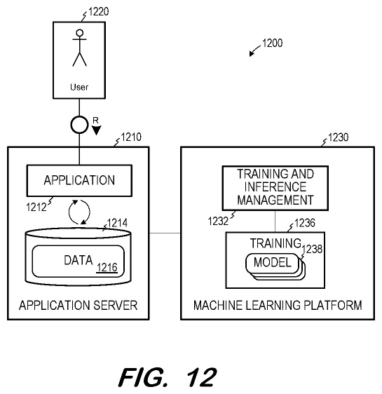

If the features are to be selected based on average weights, an average weight associated with each feature is determined at S950. The average weight for a feature may be determined by dividing the total weight determined for the feature at S910 by the number of occurrences determined for the feature at S920. At S960, the top M-ranked features are selected based on the average weights. FIG. 11 shows selected features 1100 determined at S960 based on data structure 800, and for which M=3. As illustrated in FIGS. 10 and 11, embodiments may produce two different sets of selected features based on the determination at S930.

For either S940 or S960, M may be a pre-defined number or may be based on the distribution of occurrences/average weights determined for the features. For example, if five features are associated with very high numbers of occurrences/average weights relative to the remaining features, this distribution may indicate that these five features should be selected at S940/S960. Such logic may be constrained by predefined maximum and/or minimum numbers of selected features, or any other suitable rules.

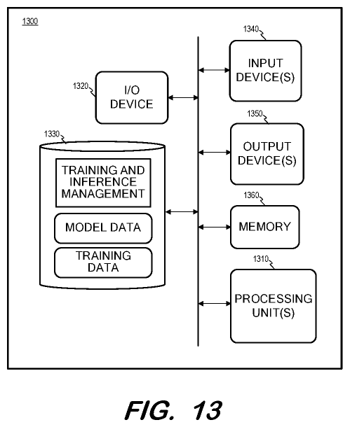

FIG. 12 illustrates system 1200 to provide model training to applications according to some embodiments. Application server 1210 may comprise an on-premise or cloud-based server providing an execution platform and services to applications such as application 1212. Application 1212 may comprise program code executable by a processing unit to provide functions to users such as user 1220 based on logic and on data 1216 stored in data store 1214. Data 1216 may be column-based, row-based, object data or any other type of data that is or becomes known. Data store 1214 may comprise any suitable storage system such as a database system, which may be partially or fully remote from application server 1210, and may be distributed as is known in the art.

According to some embodiments, user 1220 may interact with application 1212 (e.g., via a Web browser executing a client application associated with application 1212) to request a predictive model based on a set of training data. In response, application 1212 may call training and inference management component 1232 of machine learning platform 1230 to request a corresponding supervised learning-trained model according to some embodiments.

Based on the request, training and inference management component 1232 may receive training data from data 1216 and instruct training component 1236 to select features from the training data as described herein and train a model 1238 based on the selected features. Application 1212 may then use the trained model to generate predictions based on input data selected by user 1220.

In some embodiments, application 1212 and training and inference management component 1232 may comprise a single system, and/or application server 1210 and machine learning platform 1230 may comprise a single system. In some embodiments, machine learning platform 1230 supports model training and inference for applications other than application 1212 and/or application servers other than application server 1210.

FIG. 13 is a block diagram of a hardware system providing a feature selection service according to some embodiments. Hardware system 1300 may comprise a general-purpose computing apparatus and may execute program code to perform any of the functions described herein. Hardware system 1300 may be implemented by a distributed cloud-based server and may comprise an implementation of machine learning platform 1230 in some embodiments. Hardware system 1300 may include other unshown elements according to some embodiments.

Hardware system 1300 includes processing unit(s) 1310 operatively coupled to I/O device 1320, data storage device 1330, one or more input devices 1340, one or more output devices 1350 and memory 1360. I/O device 1320 may facilitate communication with external devices, such as an external network, the cloud, or a data storage device. Input device(s) 1340 may comprise, for example, a keyboard, a keypad, a mouse or other pointing device, a microphone, knob or a switch, an infra-red (IR) port, a docking station, and/or a touch screen. Input device(s) 1340 may be used, for example, to enter information into hardware system 1300. Output device(s) 1350 may comprise, for example, a display (e.g., a display screen) a speaker, and/or a printer.

Data storage device 1330 may comprise any appropriate persistent storage device, including combinations of magnetic storage devices (e.g., magnetic tape, hard disk drives and flash memory), optical storage devices, Read Only Memory (ROM) devices, and RAM devices, while memory 1360 may comprise a RAM device.

Data storage device 1330 stores program code executed by processing unit(s) 1310 to cause system 1300 to implement any of the components and execute any one or more of the processes described herein. Embodiments are not limited to execution of these processes by a single computing device. Data storage device 1330 may also store data and other program code for providing additional functionality and/or which are necessary for operation of hardware system 1300, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing processor-executable program code; and
a processing unit to execute the processor-executable program code to cause the system to:
receive a set of data, the set of data comprising a plurality of features;
for each of a plurality of randomly-selected subsets of the plurality of features, build a dimension reduction model based on the randomly-selected subset of features and values of the set of data associated with the randomly-selected subset of features;
for each dimension reduction model:
determine a weight associated with each of the randomly-selected subset of features based on the dimension model;
identify a predetermined number of features associated with the predetermined number of highest weights; and
generate, for each dimension reduction model, a data structure comprising the predetermined number of features and the weight associated with each of the predetermined number of features;
determine a plurality of top features based on the plurality of data structures; and
train a supervised learning model based on the plurality of top features of the set of data.

2. A system according to claim 1, wherein the plurality of features include a discrete feature and a plurality of continuous features, the processing unit to execute the processor-executable program code to cause the system to:
identify a target continuous feature of the plurality of continuous features; and
prior to building of the dimension reduction models, replace each discrete value associated with the discrete feature with an average of values of target continuous feature which are associated with the discrete value in the set of data.

3. A system according to claim 1, wherein building of a dimension reduction model comprises application of a principal component analysis algorithm to the randomly-selected subset of features and values of the set of data associated with the randomly-selected subset of features.

4. A system according to claim 1, wherein determination of the plurality of top features based on the plurality of data structures comprises:
determination of a number of occurrences of each feature in the plurality of data structures; and
determination of the plurality of top features based on the number of occurrences of each feature.

5. A system according to claim 1, wherein determination of the plurality of top features based on the plurality of data structures comprises:
determination of an average weight associated with each feature in the plurality of data structures; and
determination of the plurality of top features based on the average weights.

6. A method comprising:
receiving a set of data, the set of data comprising a plurality of features;
for each of a plurality of randomly-selected subsets of the plurality of features, building a dimension reduction model based on the randomly-selected subset of features and values of the set of data associated with the randomly-selected subset of features;
for each dimension reduction model:
determining a weight associated with each of the randomly-selected subset of features based on the dimension model;
identifying a predetermined number of features associated with the predetermined number of highest weights; and
generating, for each dimension reduction model, a data structure comprising the predetermined number of features and the weight associated with each of the predetermined number of features;
determining a plurality of top features based on the plurality of data structures; and
training a supervised learning model based on the plurality of top features of the set of data.

7. A method according to claim 6, wherein the plurality of features include a discrete feature and a plurality of continuous features, the method further comprising:
identifying a target continuous feature of the plurality of continuous features; and
prior to building of the dimension reduction models, replacing each discrete value associated with the discrete feature with an average of values of target continuous feature which are associated with the discrete value in the set of data.

8. A method according to claim 6, wherein building a dimension reduction model comprises applying a principal component analysis algorithm to the randomly-selected subset of features and values of the set of data associated with the randomly-selected subset of features.

9. A method according to claim 6, wherein determining the plurality of top features based on the plurality of data structures comprises:
determining a number of occurrences of each feature in the plurality of data structures; and
determining the plurality of top features based on the number of occurrences of each feature.

10. A method according to claim 6, wherein determining the plurality of top features based on the plurality of data structures comprises:
determining an average weight associated with each feature in the plurality of data structures; and
determining the plurality of top features based on the average weights.

11. A non-transitory medium storing processor-executable program code executable by a processing unit of a computing system to cause the computing system to:
receive a set of data, the set of data comprising a plurality of features;
for each of a plurality of randomly-selected subsets of the plurality of features, build a dimension reduction model based on the randomly-selected subset of features and values of the set of data associated with the randomly-selected subset of features;
for each dimension reduction model:
determine a weight associated with each of the randomly-selected subset of features based on the dimension model;
identify a predetermined number of features associated with the predetermined number of highest weights; and
generate, for each dimension reduction model, a data structure comprising the predetermined number of features and the weight associated with each of the predetermined number of features;
determine a plurality of top features based on the plurality of data structures; and
train a supervised learning model based on the plurality of top features of the set of data.

12. A medium according to claim 11, wherein the plurality of features include a discrete feature and a plurality of continuous features, the processing unit of a computing system to cause the computing system to:
identify a target continuous feature of the plurality of continuous features; and
prior to building of the dimension reduction models, replace each discrete value associated with the discrete feature with an average of values of target continuous feature which are associated with the discrete value in the set of data.

13. A medium according to claim 11, wherein building of a dimension reduction model comprises application of a principal component analysis algorithm to the randomly-selected subset of features and values of the set of data associated with the randomly-selected subset of features.

14. A medium according to claim 11, wherein determination of the plurality of top features based on the plurality of data structures comprises:
determination of a number of occurrences of each feature in the plurality of data structures; and
determination of the plurality of top features based on the number of occurrences of each feature.

15. A medium according to claim 11, wherein determination of the plurality of top features based on the plurality of data structures comprises:
determination of an average weight associated with each feature in the plurality of data structures; and
determination of the plurality of top features based on the average weights.
